(19) United States
(12) Patent Application Publication
(10) Pub. No.: US 2010/0084959 A1
(43) Pub. Date: Apr. 8, 2010

(54) LIGHT EMITTING DIODE MODULE ILLUMINATING LAMP

(76) Inventor: Hong Gun Nam, Seoul (KR)

Correspondence Address: ROTHWELL, FIGG, ERNST & MANBECK, P.C., 1425 K STREET, N.W., SUITE 800, WASHINGTON, DC, 20005, US

(21) Appl. No.: 12/349,032

(22) Filed: Jan. 6, 2009

(30) Foreign Application Priority Data
Oct. 2, 2008 (KR) 10-2008-0097037

(51) Int. Cl. H01K 1/26

(52) U.S. Cl. 313/116

(57) ABSTRACT

The present invention relates to a light emitting diode module illuminating lamp which is provided with a main body provided with a light irradiating part, a support and a support panel integrally formed together and formed with a inserting part at an outer perimeter thereof and a light emitting source placed within the main body and provided with a light emitting diode and a reinforcing support panel, and is able to uniformly irradiate the light of the light emitting diode emitted from an inside of the main body to an outside, obtain an effect as if a plurality of light irradiating parts were used by using a single light irradiating part and reduce the number of the light irradiating parts per unit area to save a cost.

The light emitting diode module illuminating lamp includes a main body (10) provided with a light irradiating part (11) of which upper surface is formed in a semicircular convexed part so as to uniformly irradiate a light from an inside light source to an outside, a lower support panel (12) formed correspondingly to the light irradiating part (11) and a support which connects a lower part of the light irradiating part (11) and an upper part of the lower support panel (12) and allows an inserting part (14) to be provided in an outer circumference thereof; and a light emitting source (20) installed in an inside of the main body (10).

### CROSS REFERENCE TO RELATED APPLICATION(S)

This application claims the benefit of Korean Application No. 10-2008-0097037, filed Oct. 2, 2008, the disclosure of which is incorporated herein in its entirety by reference.

### DESCRIPTION

1. Technical Field

The present invention relates to a light emitting diode module illuminating lamp which is provided with a main body provided with a light irradiating part, a support and a support panel integrally formed together and formed with a inserting part at an outer perimeter thereof and a light emitting source placed within the main body and provided with a light emitting diode and a reinforcing support panel, and is able to uniformly irradiate the light of the light emitting diode emitted from an inside of the main body to an outside, obtain an effect as if a plurality of light irradiating parts were used by using a single light irradiating part and reduce the number of the light irradiating parts per unit area to save a cost.

2. Background Art

In general, in a light emitting apparatus or a light emitting diode module illuminating lamp, a lot of light source are disposed with a predetermined spacing when uniform brightness of the light is required since light from a light source passing through a region in which the light is diffused on a flat panel is irradiated only in the vicinity of the light source and a section which is out of the critical angle adjacent to the light source is remained in the dark.

Therefore, there has been a problem that it takes much cost for materials as well as labor to install these many light sources.

In order to solve the problem, “Light emitting apparatus” in Korean Patent No. 10-0541242 discloses, as shown in FIG. 1, a light emitting apparatus including a convex lens type convexed part 110 in which a lower surface forms a flat plane, an inside transmits a light from an inside light source and an upper surface forms a convexed surface to have a reflection angle causing that the light from the inside light source is irradiated onto a surface with uniform illuminance, an inserting hole 120 formed at a center of the lower surface of the convexed part 110 in an axial direction, a light emitting lamp 130 which is an inside light source and is inserted in the inserting hole 120, a reflection layer 140 coupled integrally to the flat lower surface of the convexed part 110 and an edge part 113 on a supporting ring plate coupled integrally to a circumference of the convexed part 110.

Since the light emitting apparatus is not stably fixed when installing the light emitting apparatus by forming a through hole 210 at a portion where the light emitting apparatus is installed and then coupling an inner circumference of the through hole 201 to an upper face of the edge part 113, there is a problem that a separate adhesive member should be provided on the edge part 113 to stably fix the light emitting apparatus.

Also, when installing the light emitting apparatus by coupling to the through 201 formed in a mat 200 which is subject to a pressure from the above, the convexed part 10 at an upper portion of the light emitting apparatus may be subject to surface damage by repeated downward pressure and collision or impact by foreign objects and thus cannot effectively irradiate the light from the light emitting lamp 30 installed within the inside thereof to the outside. Otherwise, the convexed part 110 may be broken by the downward pressure and collision or impact by foreign objects, which causes problems of troublesome of replacing the light emitting lamp 130 itself and generation of rise of a cost for materials of the light emitting lamp 130.

Also, since a wiring of the light emitting lamp 130is formed at a lower portion of the light emitting lamp 130, there is a troublesome that a separate wiring is required when connecting the light emitting lamp 130 with another light emitting lamp in the state that the light emitting lamp 130 is inserted and installed in the inserting hole 120 of the light emitting apparatus.

In addition, there is a problem that when the light emitting lamp 130 is inserted in the inserting hole 120 at the lower portion of the light emitting apparatus and the light emitting apparatus is installed in the through hole 201 of the mat 200, a connection wire for supplying power to the light emitting lamp 130 may be cut and the light emitting lamp 130 cannot emit the light as the light emitting lamp inserted in the inside of the inserting hole 120 is subject to repeated movement by the repeated impact and downward pressure on the outside of the light emitting apparatus.

### DISCLOSURE

1. Technical Problem

An object of the present invention is to provide a light emitting diode module illuminating lamp which is provided with a main body provided with a light irradiating part, a support and a support panel integrally formed together and formed with a inserting part at an outer perimeter thereof and a light emitting source placed within the main body and provided with a light emitting diode and a reinforcing support panel and is able to uniformly irradiate the light of the light emitting diode emitted from an inside of the main body to an outside, obtain an effect as if a plurality of light irradiating parts were used by using a single light irradiating part and reduce the number of the light irradiating parts per unit area to save a cost.

2. Technical Solution

To achieve the above objects, the present invention provides a light emitting diode module illuminating lamp, which includes a main body provided with a light irradiating part of which upper surface is formed in a semicircular convexed part so as to uniformly irradiate a light from an inside light source to an outside, a lower support panel formed correspondingly to the light irradiating part and a support which connects a lower part of the light irradiating part and an upper part of the lower support panel and allows an inserting part to be provided in an outer circumference thereof; and a light emitting source installed in an inside of the main body.

The main body is formed on selected from a transparent material or a semitransparent material.

The light emitting source is provided with a reinforcing support panel in which a cathode line and an anode line are formed so as to be exposed at both sides of the reinforcing support panel and a light emitting diode installed at an upper portion of the reinforcing support panel and connected with the cathode line and the anode line.

The support includes a lower coupling support formed at a lower portion of the light emitting part and an upper coupling support formed at an upper portion of the support panel, and an outer circumference of the lower coupling support is coupled to an inner circumference of the upper coupling support.

A thread formed on an outer circumference of the lower coupling support may be screw fastened to a thread formed on an inner circumference of the upper coupling support.

The main body includes a support extended downwardly from an upper periphery of the light emitting part with the same shape as the periphery of the light irradiating part and a fixing ring connected with the support panel formed wider than the lower portion of the support and inserted onto the outer circumference of the support.

An inner circumference of the fixing ring is coupled to an outer circumference of the support or a thread formed on the inner circumference of the fixing ring may be screw fastened to a thread formed on an outer circumference of the support.

3. Advantageous Effects

The present invention has advantages of uniformly irradiating the light of the light emitting diode emitted from an inside of the main body to an outside, obtaining an effect as if a plurality of light irradiating parts were used by using a single light irradiating part and reducing the number of the light irradiating parts per unit area to save a cost.

Also, the present invention has advantages of protecting the light emitting diode, the cathode line and the anode line from an upper pressure and an external impact and previously preventing malfunction of the light emitting source by forming the reinforcing support panel at a lower portion of the light emitting diode which is the light emitting source.

Also, the inserting part is formed at the outer circumference of the support, an outer circumference of the inserting part is inserted in the through hole of the mat which is subject to an upper pressure, the lower face of the light irradiating part is in close contact with an upper circumferential face of the through hole and the support panel is in close contact with a lower circumferential face of the through hole. Therefore, there is an advantage that the light emitting diode module illuminating lamp can be more stably and firmly installed.

In addition, in the case that the support is installed to the mat in a state of being divided into the upper coupling support formed at the upper portion of the support panel and the lower coupling support formed at a lower portion of the light emitting part, the light irradiating part can be easily replaced by easily separating the lower coupling support of the light irradiating part from the upper coupling support when the light irradiating part is damaged or broken. Therefore, there is an advantage of reducing troublesome of replacing the entire light emitting lamp and a cost for materials therefor.

Further, when the outer circumference of the support is inserted in the through hole of the mat and the fixing ring is screw fastened to the support, it is possible to more easily couple the light emitting apparatus to the mat. Therefore, there is an advantage of reducing time to be taken and labor for the installation and thus saving the cost.

Furthermore, by forming the cathode line and the anode line, which are the wirings connected with the light emitting diode, at both sides of the light emitting diode, no separate wiring which is required in the conventional light emitting apparatus when a plurality of the light emitting lamps is required and there is a convenient effect of connecting to the cathode lines and the anode lines exposed at both sides of the light emitting diode.

### DESCRIPTION OF DRAWINGS

The above and other objects, features and advantages of the present invention will become apparent from the following description of preferred embodiments given in conjunction with the accompanying drawings, in which:

FIG. 1 is an exemplary view showing a conventional light emitting apparatus.

FIG. 2 is a view illustrating a first embodiment of the present invention.

FIG. 3 is a perspective view illustrating a light emitting source according to the present invention.

FIG. 4 is a view illustrating a second embodiment of the present invention.

FIG. 5 is a view illustrating a third embodiment of the present invention.

FIG. 6 is a view illustrating a fourth embodiment of the present invention.

FIG. 7 is a view illustrating a fifth embodiment of the present invention.

FIGS. 8a and 8b are views illustrating installation according to the present invention.

FIG. 9 is a view illustrating a sixth embodiment of the present invention.

FIG. 10 is a view illustrating a seventh embodiment of the present invention.

### DETAILED DESCRIPTION OF MAIN ELEMENTS

10: main body

11: light irradiating part

12: lower support panel

13: support

13a: lower coupling support

13b: upper coupling support

14: inserting part

20: light emitting source

21: cathode line

22: anode line

23: reinforcing support panel

24: light emitting diode

30: fixing ring

100: light emitting diode module illuminating lamp

### BEST MODE

Hereinafter, embodiments of the present invention will be described in detail with reference to accompanying drawings.

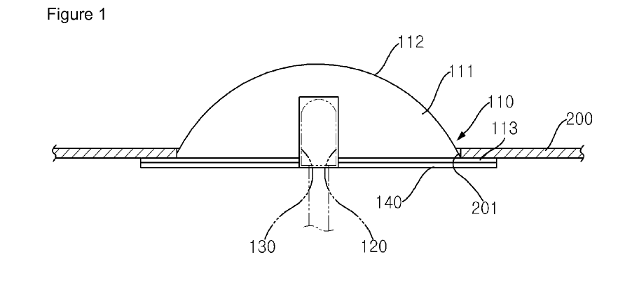

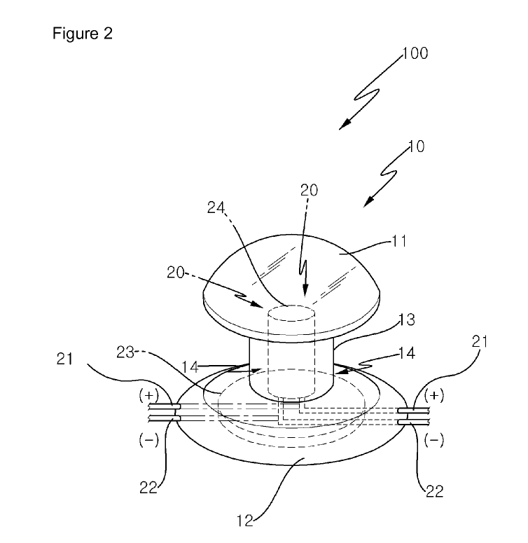

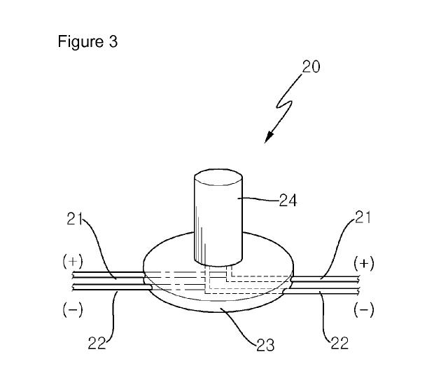

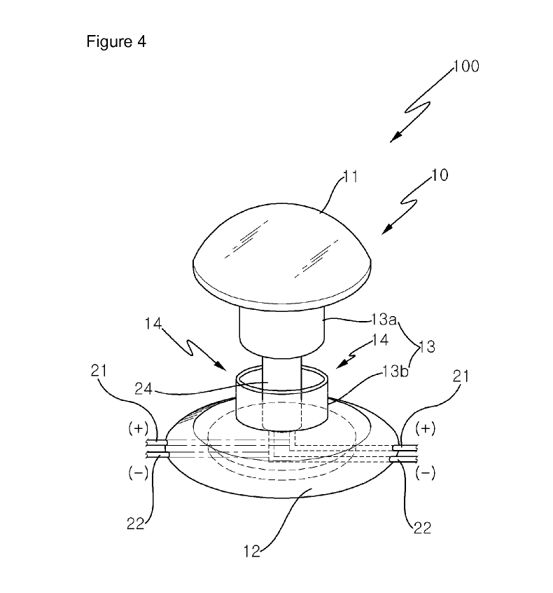

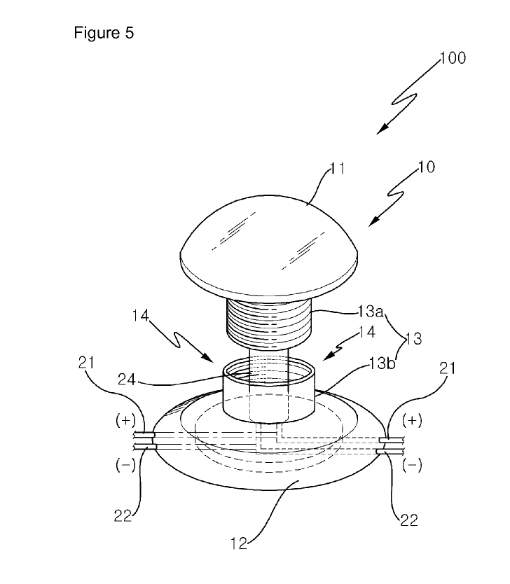

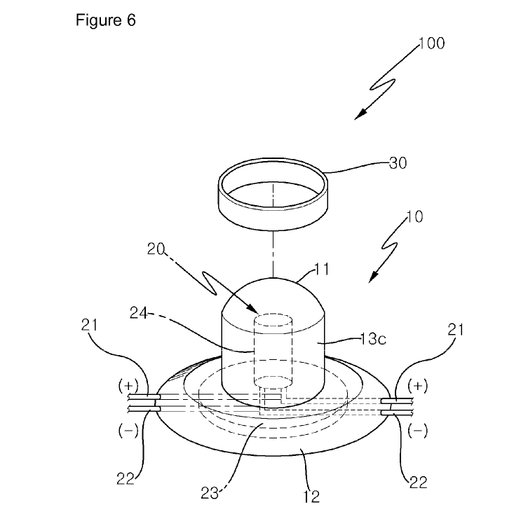

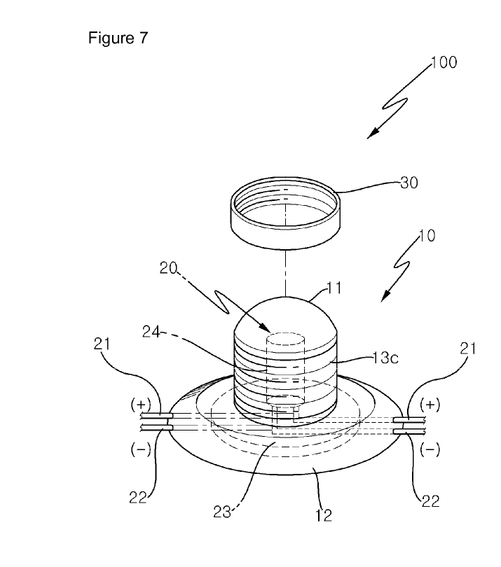

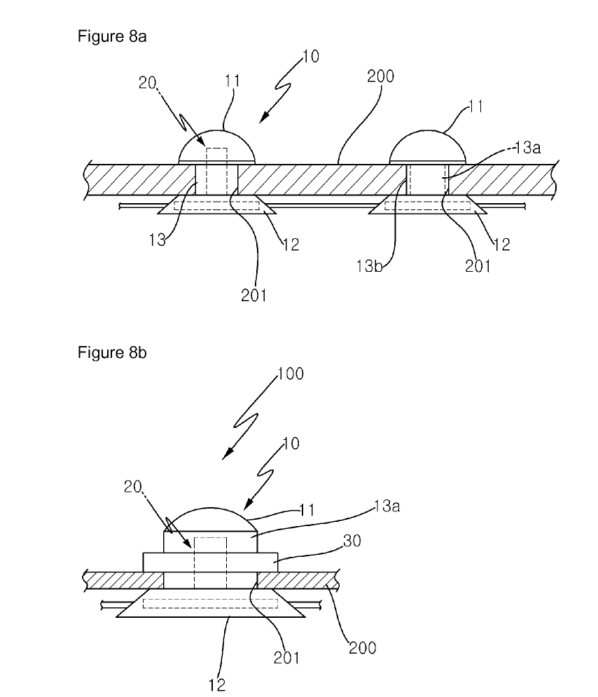

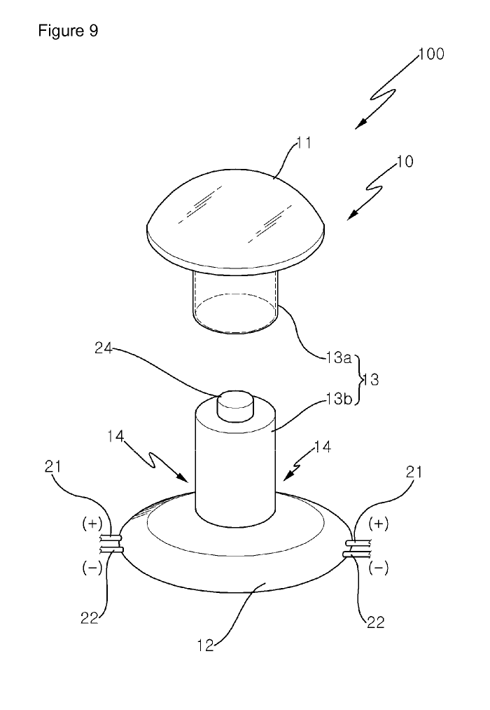

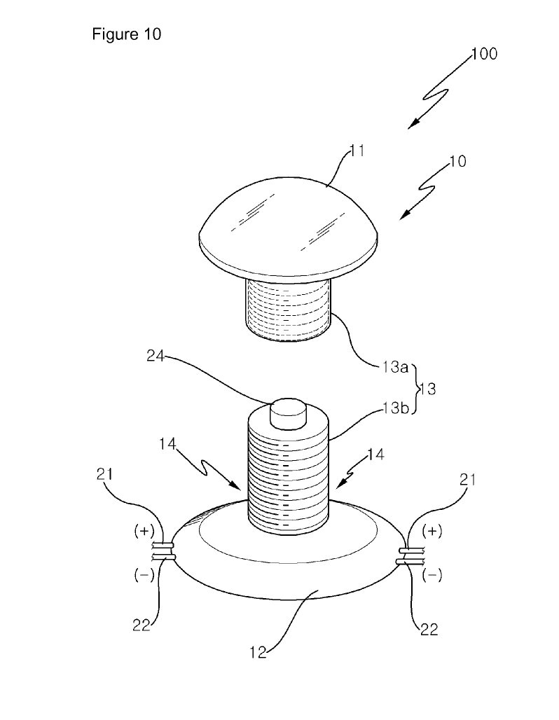

FIG. 1 is an exemplary view showing a conventional light emitting apparatus; FIG. 2 is a view illustrating a first embodiment of the present invention; FIG. 3 is a perspective view illustrating a light emitting source according to the present invention; FIG. 4 is a view illustrating a second embodiment of the present invention; FIG. 5 is a view illustrating a third embodiment of the present invention; FIG. 6 is a view illustrating a fourth embodiment of the present invention; FIG. 7 is a view illustrating a fifth embodiment of the present invention; FIGS. 8a and 8b are views illustrating installation according to the present invention; FIG. 9 is a view illustrating a sixth embodiment of the present invention; and FIG. 10 is a view illustrating a seventh embodiment of the present invention.

A light emitting diode module illuminating lamp according to the present invention will be described in detail with reference to FIGS. 2 through 10.

A light emitting diode module illuminating lamp 100 according to the present invention includes a main body 10 and a light emitting source 20.

As shown in FIG. 2, the main body 10 includes, as its upper surface, a light irradiating part 11 formed in a semicircular convexed part so as to uniformly irradiate a light inside thereof to an outside.

Also, the main body 10 further includes a lower support panel 12 formed correspondingly to the light irradiating part 11.

In addition, the main body 10 further includes a support which connects a lower part of the light irradiating part 11 and an upper part of the lower support panel 12 and allows an inserting part 14 to be provided in an outer circumference thereof.

The main body 10 is formed of a transparent or semitransparent material to effectively illuminate the light emitted from the light emitting source 20.

The light emitting source 20 is installed, as shown in FIG. 3, in an inside of the main body 10.

Also, the light emitting source 20 is formed with a reinforcing support panel 23 in which a cathode line 21 and an anode line 22 are formed so as to be exposed at both sides of the reinforcing support panel 23.

The reason that the cathode line 21 and the anode line 22 are formed at both sides of the reinforcing support panel 23 is for installing a plurality of the light emitting sources 20 with being connected to one another.

Preferably, the light emitting source 20 includes a light emitting diode 24 installed at an upper portion of the reinforcing support panel 23 and connected with the cathode line 21 and the anode line 22.

Also, the reinforcing support panel 23 is for stably fixing the light emitting diode 24 and protecting the light emitting diode 24, the cathode line 21 and the anode line 22 from upper or external pressure.

The cathode line 21 and the anode line 22 are formed so as to be exposed to the_12 is for enabling that a plurality of the light emitting apparatuses can be connected without separate wiring work for the light emitting diode 24.

As shown in FIG. 4, the support 13 includes a lower coupling support 13a formed at a lower portion of the light emitting part 11 and an upper coupling support 13b formed at an upper portion of the support panel 12.

The lower coupling support 13a and the upper coupling support 13b are coupled in such a manner that an outer circumference of the lower coupling support 13a is inserted in an inner circumference of the upper coupling support 13b.

As shown in FIG. 9, the lower coupling support 13a and the upper coupling support 13b may be coupled in such a manner that an inner circumference of the lower coupling support 13a is inserted in an outer circumference of the upper coupling support 13b.

The reason that the support 13 is divided into the lower coupling support 13a and the upper coupling support 13b is for facilitating replacement of the light irradiating part 11 due to the breakage and damage of the light irradiating part 11 by easily separating and coupling the light irradiating part 11 formed with the lower coupling support 13a at the lower portion thereof from and to the lower coupling support 13b since the support panel 12 formed with the upper coupling support 13b at the upper portion thereof is coupled to a through hole 201 at a lower portion of the mat 200.

As shown in FIG. 5, a thread formed on an outer circumference of the lower coupling support 13a may be screw fastened to a thread formed on an inner circumference of the upper coupling support 13b.

Also, as shown in FIG. 10, a thread formed on an inner circumference of the lower coupling support 13a may be fastened to a thread formed on an outer circumference of the upper coupling support 13b.

As shown in FIGS. 6 and 7, the main body 10 may includes a support 13c extended downwardly from an upper periphery of the light emitting part 11 with the same shape as the periphery of the light irradiating part 11 and a fixing ring 30 connected with the support panel 12 formed wider than the lower portion of the support 13c and inserted onto the outer circumference of the support 13c.

That is, the support 13 and the light emitting part 11 are formed in a vertical bar shape with the same width.

In other words, the light irradiating part 11 is formed in the same size as the upper face of the support 13.

Also, an inner circumference of the fixing ring 30 is coupled to an outer circumference of the support 13c.

Further, a thread formed on the inner circumference of the fixing ring 30 may be screw fastened to a thread formed on an outer circumference of the support 13c.

This is for facilitating installation of the main body by causing the support 13c to be exposed at an upper portion of the mat 200 and thus easily coupling the fixing ring 30 to the support 13c when the support 13c is inserted in the through hole 201 and the support panel is placed at a lower portion of the mat 200.

FIG. 8a illustrates installation of the light emitting diode module illuminating lamp 100 according to the present invention. As shown, the outer circumference of the support 13 is inserted in the through hole 201 of the mat 200, seated in an inserting part 14 on the outer circumferential part of the support 13 in which the mat 200 is placed, the upper face of the support panel supports the lower face of the mat 200 and the lower face of the light irradiating part 11 supports the upper face of the mat 200, thereby fixing the light emitting diode module illuminating lamp 100 to the mat 200.

FIG. 8b illustrates another installation of the light emitting diode module illuminating lamp 100 according to the present invention. As shown, the support 13c is inserted in the through hole 201 of the mat 200 so as to be exposed to the upper portion of the mat 200, the upper portion of outside of the lower support panel 12 The reason of installing the cathode line 21 and the anode line 22 at both sides of the support panel the support panel 12 and the lower face of the mat 200 are in close contact with each other. After that, the fixing ring 30 is fixedly inserted onto the support 13c from the upper portion of the support 13c to the lower portion of the support 13c, or the thread formed on the outer circumference of the support 13c and the thread formed on the inner circumference of the fixing ring 30 are screw fastened, whereby the fixing ring 30 fixes the upper face of the mat 200 at the outer circumference of the support 30.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

1. A light emitting diode module illuminating lamp, comprising:
a main body (10) provided with a light irradiating part (11) of which upper surface is formed in a semicircular convexed part so as to uniformly irradiate a light from an inside light source to an outside, a lower support panel (12) formed correspondingly to the light irradiating part (11) and a support which connects a lower part of the light irradiating part (11) and an upper part of the lower support panel (12) and allows an inserting part (14) to be provided in an outer circumference thereof; and a light emitting source (20) installed in an inside of the main body (10).

2. The light emitting diode module illuminating lamp according to claim 1, wherein the main body (10) is formed on selected from a transparent material or a semitransparent material.

3. The light emitting diode module illuminating lamp according to claim 1, wherein the light emitting source (20) is provided with a reinforcing support panel (23) in which a cathode line (21) and an anode line (22) are formed so as to be exposed at both sides of the reinforcing support panel (23) and a light emitting diode (24) installed at an upper portion of the reinforcing support panel (23) and connected with the cathode line (21) and the anode line (22).

4. The light emitting diode module illuminating lamp according to claim 1, wherein the support (13) includes a lower coupling support (13a) formed at a lower portion of the light emitting part (11) and an upper coupling support (13b) formed at an upper portion of the support panel (12), and an outer circumference of the lower coupling support (13a) is coupled to an inner circumference of the upper coupling support (13b).

5. The light emitting diode module illuminating lamp according to claim 4, wherein a thread formed on an outer circumference of the lower coupling support (13a) is screw fastened to a thread formed on an inner circumference of the upper coupling support (13b).

6. The light emitting diode module illuminating lamp according to claim 1, wherein the main body (10) includes a support (13c) extended downwardly from an upper periphery of the light emitting part (11) with the same shape as the periphery of the light irradiating part (11) and a fixing ring (30) connected with the support panel (12) formed wider than the lower portion of the support (13c) and inserted onto the outer circumference of the support (13c).

7. The light emitting diode module illuminating lamp according to claim 6, wherein an inner circumference of the fixing ring (30) is coupled to an outer circumference of the support (13c) or a thread formed on the inner circumference of the fixing ring (30) may be screw fastened to a thread formed on an outer circumference of the support (13c).
